(19) United States
(12) Patent Application Publication
(10) Pub. No.: US 2017/0259491 A1
(43) Pub. Date: Sep. 14, 2017

(54) METHOD AND APPARATUS FOR TRACKING WELD DATA

(71) Applicant: Miller Weldmaster Corporation, Navarre, OH (US)

(72) Inventors: Zachary J. Ralston, Canton, OH (US); Jeffrey P. Sponseller, Massillon, OH (US)

(21) Appl. No.: 15/611,165

(22) Filed: Jun. 1, 2017

Related U.S. Application Data
(63) Continuation-in-part of application No. 15/296,697, filed on Oct. 18, 2016.
(60) Provisional application No. 62/244,311, filed on Oct. 21, 2015.
(60) Provisional application No. 62/344,458, filed on Jun. 2, 2016.

(51) Int. Cl. B29C 65/18; G01D 7/00; G01S 19/13

(52) U.S. Cl. CPC B29C 65/18; G01S 19/13; G01D 7/00; B29L 2031/108

(57) ABSTRACT

A moveable seam welding machine, system, and method of use is provided. The seam welding machine includes at least one sensor that generates at least one data point having geolocation coordinates incorporated or integrally formed therewith. The data point typically relates to the integrity or quality of the welded seam created by the machine. The sensor generates data points which may be evaluated in alarm logic for abnormalities or anomalies. The geolocation coordinates inherent or integral to the data point may be plotted or registered overtop satellite imagery. The coordinates of the anomalies or the registered image, or both, can be provided to the workman or operator so he/she may manually inspect the geolocation at where the abnormal or anomaly data point was generated by the sensor to spot check the welded seam by hand.

### CROSS REFERENCE TO RELATED APPLICATIONS

This application is a continuation-in-part application of prior co-pending U.S. patent application Ser. No. 15/296,697, filed on Oct. 18, 2016, which claims the benefit of U.S. Provisional Patent Application Ser. No. 62/244,311, filed on Oct. 21, 2015; the disclosures of which are entirely incorporated herein by reference as if fully rewritten.

This application claims the benefit of prior co-pending U.S. Provisional Patent Application Ser. No. 62/344,458, filed on Jun. 2, 2016; the disclosure of which is entirely incorporated herein by reference as if fully rewritten.

### BACKGROUND

### Technical Field

The present disclosure relates generally to welding equipment. More particularly, the present disclosure is directed to a welding machine useful for welding membranes and other flexible fabrics. Specifically, the present disclosure is directed to a welding machine and a method of welding flexible fabrics where the machine is operable in forward and reverse directions.

### Background Information

Large commercial buildings frequently have some type of flexible, waterproof roofing membrane installed on their roofs. The roofing membrane is provided in elongate strips that are arranged side-by-side across the surface of the roof. The edges of adjacent strips are overlapped with each other and are subsequently secured together to provide a waterproof surface over the roof. There are a number of ways of securing the overlapped edges of the strips together, one of which is heat welding them to each other.

A variety of welding machines have been developed for this purpose. These machines include a nozzle with a welding head that is positionable between the overlapped edges of the strips of roofing membrane and the welding head is used to apply heat to the overlapped region. One or more rollers for applying pressure to the heated overlapped region are also provided on the machine. The rollers are positioned on one side of the welding head and in such a way that they will substantially immediately contact the heated overlapped region and apply pressure thereto. The combination of heat and pressure bonds the overlapped region of two adjacent strips of roofing membrane together.

The nozzle on some of these prior art machines may be mounted on an arm that extends laterally outwardly from one side of the machine. The nozzle is slidable along the arm and is able to be moved away from the side of the machine when welding is not occurring and toward the side of the machine when getting ready to weld. The nozzle is mounted on the arm in such a way that it is able to pivot about and axis extending along the arm. The nozzle may be pivoted downwardly toward the roofing surface or upwardly away from the roofing surface. When the machine is being readied to weld, the nozzle is first pivoted downwardly toward the roofing surface and is then slid along the arm toward the side of the machine. Because of the orientation of the welding head on the nozzle, when the nozzle is slid toward the machine, the welding head moves at least partially under the bottom wall of the machine. In this position the welding head is able to be placed between the overlapped edge of one strip of roofing membrane and the underlapped edge of the other strip of roofing membrane. Welding can then commence. When welding of the overlapped region is completed, the operator slides the nozzle laterally away from the side of the machine and then pivots the nozzle upwardly about an axis extending along the arm, thus moving the hot welding head away from the roofing surface. It should be noted that power is provided to the welding machine via cables that connect to a generator. The generator typically is lifted onto the roof for this purpose and this operation may require the use of a crane because of the weight of such generators. Additionally, the cables required to connect the generator and welding machine together may be long and have to be kept clear of the part of the roofing membrane that is being welded. Frequently, roofing company will have to have a person dedicated to watching and moving the cable on the roof so that this task does not interfere with the operation of the welding machine.

During welding operations, several strips of roofing membrane may need to be placed side-by-side to cover the roof surface. There may therefore be a number of individual overlapped regions that have to be welded in order to create the waterproof covering. These overlapped regions will tend to be spaced laterally from each other and generally parallel to each other. Additionally, each overlapped region tends to extend from proximate a first end of the roof to proximate a second end thereof. An operator will position the welding machine at a beginning of a first overlapped region at the first end of the roof and will weld that first overlapped region using the machine, ending at the second end of the roof. The machine then has to then be moved laterally over to the second overlapped region. Because of the presence of the cable and the configuration of the welding machine itself, it is necessary to move the welding machine from the second end of the roof back to the first end thereof and then move the welding machine laterally across to the beginning of the second overlapped region. It has been found with prior art machines that turning the machine around at the second end of the roof so as to face the other way and then moving the machine laterally across to the second overlapped region simply does not work. This is because the nozzle and welding head will then be positioned to face in the wrong direction to be able to enter between the overlapped and underlapped edges of the second overlapped region.

Additionally, if the machine is rotated through 180°, it is very likely that the cable will then extend across the second overlapped region and therefore be in the welding path of the machine. If this is not the case then the cable may have to be draped over the top of the hot machine or be positioned rearwardly thereof and thereby be constantly in the way of the operator. For these reasons alone, welding with the machine in this rotated orientation is not possible. Operators therefore have to drag the welding machine back to the first end of the roof in its original un-rotated orientation and then shift it laterally across the roof. Welding of several strips of roofing membrane always takes place in the same single direction; namely, from the first end of the roof to the second end of the roof. No welding takes place from the second end of the roof to the first end unless the orientation of the overlap of the adjacent strips of roofing membrane is changed to accommodate the orientation of the welding head on the machine. In reality, alternating the overlapping just simply won't occur as it is far too time consuming for a company to undertake. It is quickly and easier to drag the machine back to the first end after completing each welding run.

After the seams have been welding, an operator must visually spot-check, then manually check, and then confirm the seam integrity. This takes significant effort of a person because they need to walk the entire roof while physically inspecting seam integrity, usually with a seam-checking tool. Furthermore, the person inspecting the integrity of the welded seams cannot determine potential “problems spots” based on the welding machine's performance.

### SUMMARY

Issues continue to exist with methods and devices for welding roof material together, particularly when it comes to checking/inspecting the integrity of the seam. Thus, a need exists for a method and device for tracking weld data in order to later check a seam at a distinct spot based on the data. The present disclosure addresses these and other issues.

In one aspect, an embodiment of the present disclosure may provide a method and apparatus for tracking and checking seam weld data with a “seam rover” (i.e., a moveable welding machine) that has a GPS and built-in memory or a removable memory (such as a SD card) for documenting critical weld data and GPS location. The memory may be reset for every job or a new SD card may be used for every job and the data securely stored on the SD card in a safe location. The seam rover device includes a plurality of sensors that sense weld data and a computer can record the following non-limiting and exemplary parameters to the memory: traveled welding distance, date and time, set temperature, actual temperature, device speed, blower output percentage, ambient temperature, ambient humidity, and latitude and longitude positioning. Then, this data may uploaded to a custom application webpage or mobile application. Once the data file has been uploaded, software or other logic will chart the welding parameters in an easily readable format. The data will be plotted on a graph for quick identification of any anomalies (such as graph apexes or graph depressions) in welding parameters. The GPS Data will be plotted onto a satellite printable map for tracking of welds and data. From the GPS data, a human investigator may physically track and investigate the weld at the location of an anomaly to determine the seam integrity, strength, usefulness, or other known quality identifier. Additionally, the software will quickly help identify the location on the roof where the suspect weld may have occurred based upon corresponding parameters.

In one aspect, a non-limiting and exemplary embodiment of the present disclosure may provide a moveable rooftop seam welding machine comprising: at least one sensor carried by the machine configured to sense data associated with at least one of the following during a rooftop welding process: location information, welding temperature, machine speed, ambient air temperature, and ambient humidity; and a memory in electrical communication with the at least one sensor configured to store the sensed data. This embodiment may also include wherein the memory is repeatably removable from the machine and adapted to be uploaded onto a computer to create a spreadsheet incorporating alarm logic notifying an operator of an anomaly or abnormality in the sensed data. This embodiment may also include, in combination with a computer configured to read the sensed data from the memory, the combination comprising: a spreadsheet tabulating the sensed data; alarm logic operable with the spreadsheet to alarm the operator if some of the sensed data varies from either a set value or an average value associated with the sensor and identifying the data point of the varying data as a weld anomaly or weld abnormality needing to be inspected by an operator; and a coordinated-based location on the roof associated with the data point for which the weld anomaly or weld abnormality was identified.

In one aspect, a non-limiting and exemplary embodiment of the present disclosure may provide a method of tracking welded seam data comprising the steps of: moving a rooftop seam welding machine along an overlapping region defined by adjacent overlapped strips of rooftop sheet material; welding the overlapping region as the machine moves therealong and simultaneously sensing data associated with the welding with one or more sensors carried by the machine, wherein the sensed data includes coordinate-based location data for each data point; determining if the sensed data varies from a data threshold set, and if so, then alerting an operator of a potential weld failure at the coordinated-based location of that data point associated where the data varied from the data threshold set; and physically checking the welded seam integrity at the coordinated-based location of that data point associated where the data varied from the data threshold set. This embodiment may also include wherein the step of determining if the sensed data varies from a data threshold set is accomplished by determining if a sensed temperature exceeds a set temperature value by more than 10 degrees. This embodiment may also include wherein the step of determining if the sensed data varies from a data threshold set is accomplished by determining if a sensed temperature is less than 10 degrees or more from a set temperature value. This embodiment may also include wherein the step of determining if the sensed data varies from a data threshold set is accomplished by: establishing an average speed of the machine moving along the overlapped region; determining if the speed of the machine at a single data point varies more or less than a set percentage, such as +/−3% or +/−5% or +/−10% or +/−15% or +/−20% or +/−25% from the average speed, and if the speed at the data point varies more than the set percentage, then indicating this data point as an anomaly and alerting the operator of the anomaly that needs physically inspected by an operator.

In yet another aspect, the present disclosure may provide a moveable seam welding machine, system, and method of use. The seam welding machine includes at least one sensor that generates at least one data point having geolocation coordinates incorporated therein. The data point typically relates to the integrity of the welded seam created by the sensor on the machine as it is moved along adjacent strips of overlapped material to create a uniform weld therebetween. Once welded, the two adjacent strips become one inasmuch as no additional material is needed to create the bond between the two strips. The sensor generates data points which may be evaluated in alarm logic for abnormalities or anomalies. In the event an anomaly is detected, an alarm may be generated by a computer or smartphone. Furthermore, the geolocation coordinates inherent or integral to the data point may be plotted overtop satellite imagery. This can be provided to the workman or operator so he may manually inspect the geolocation at where the data point was generated by the sensor to spot check the welded seam by hand at the point identified as anomalies by the alarm logic. In the event the seam is sufficient, no further action needs to be taken. However, if the workman identifies a weak point or failure of the welded seam, he may correct it. This method of inspection based on the coordinates of the sensed data should increase the efficiency of the material inspection insofar as the entire material no longer needs to be meticulously inspected which increases costs. Rather, only the “alarming” areas can be thoroughly checked by hand and the remaining portions of material may be visually inspected.

In another aspect, an exemplary embodiment of the present disclosure may provide a moveable seam welding machine, system, and method of use. The seam welding machine includes at least one sensor that generates at least one data point having geolocation coordinates incorporated or integrally formed therewith. The data point typically relates to the integrity or quality of the welded seam created by the machine. The sensor generates data points which may be evaluated in alarm logic for abnormalities or anomalies. The geolocation coordinates inherent or integral to the data point may be plotted or registered overtop satellite imagery. The coordinates of the anomalies or the registered image, or both, can be provided to the workman or operator so he/she may manually inspect the geolocation at where the abnormal or anomaly data point was generated by the sensor to spot check the welded seam by hand.

In yet another aspect, an exemplary embodiment of the present disclosure may provide a moveable seam welding machine comprising: at least one sensor carried by the machine configured to generate at least one data point associated with at least one of the following during a welding process: welding plate temperature, blown air temperature, welded seam temperature, pressure exerted by at least one pressure roller, machine speed, ambient air temperature, and ambient humidity; and wherein the at least one data point includes geolocation coordinates identifying the location where the at least one data point was generated by the at least one sensor, wherein the at least one data point is adapted to be tabulated and plotted to identify the geolocation coordinates in the event there is an anomaly or abnormality in the at least one data point relative to a set threshold so as to allow an operator to manually inspect the welded seam at the coordinate-based location of the anomaly or abnormality. This example or another example may further provide a heater and a roller adapted to respectively heat and apply pressure to overlapping strips of material thereby effectuating a welded seam as the seam welding machine moves along the overlapped material. This example or another example may further provide at least one memory in operative communication with the at least one sensor configured to store data points as they are generated by the at least one sensor and store them for later plotting and tabulation. This example or another example may further provide wherein the memory is carried by the machine. This example or another example may further provide wherein the memory is repeatably removable from the machine and adapted to be uploaded onto a computer to create a spreadsheet; and alarm logic in operative communication with the spreadsheet notifying an operator of the anomaly or abnormality in the sensed data. This example or another example may further provide wherein the at least one data point includes a first data point and a second data point generated by the at least one sensor; an anomaly detected in the first data point when the first data point differs by more than about +/−25% from the second data point. This example or another example may further provide wherein the at least one data point includes a first data point and a second data point generated by the at least one sensor; an anomaly detected in the first data point when the first data point differs by more than about +/−15% from a set threshold value established prior to initiating the welding process. This example or another example may further provide a wireless link between the machine and a remote computer, wherein communication logic carried by the machine transmits the at least one data point to the remote computer for tabulation. This example or another example may further provide wherein the remote computer determines if the at least one data point deviates from a set threshold so as to generate an alarm or indicator of the physical location to be manually inspected. This example or another example may further provide wherein the sensor is selected from a group comprising: a thermometer, an accelerometer, a gyroscope, an altimeter, an impeller, a Global Positioning System (GPS), a photo sensor, a light sensor, a temperature sensor, a pressure sensor, a moisture sensor, a speedometer, and a tachometer. This example or another example may further provide in combination with a computer configured to read the sensed data from a memory storing the at least one data point, the combination comprising: a spreadsheet tabulating the sensed data; alarm logic operable with the spreadsheet to alarm the operator if some of the sensed data varies from either the set threshold or an average value associated with the at least one sensor and identifying the data point of the varying data as the anomaly or abnormality needing to be inspected by an operator; and a coordinated-based location on the roof associated with the data point for which the weld anomaly or weld abnormality was identified. This example combination or another example combination may further provide overhead imagery of the welded material having graphical representations of the anomalies or abnormalities registered thereon. This example or another example may further provide wherein the overhead imagery is satellite imagery. This example combination or another example may further provide wherein the machine is positioned on a rooftop and the material is rooftop sheet material. This example combination or another example may further provide wherein the machine is positioned on the ground and the material is selected from the group comprising: a pond liner or a landfill liner.

In yet another aspect, an exemplary embodiment of the present disclosure may provide a method of tracking welded seam data comprising the steps of: moving a seam welding machine along an overlapping region defined by adjacent overlapped strips of sheet material; welding the overlapping region to create a welded seam as the machine moves therealong and simultaneously sensing data associated with the welded seam with one or more sensors carried by the machine, wherein the sensed data includes coordinate-based location data for each data point; determining if the sensed data varies from a data threshold set, and if so, then alerting an operator of a potential weld failure at the coordinated-based location of that data point associated where the data varied from the data threshold set; and effecting the manual and physical spot checking the welded seam integrity at the coordinated-based location of that data point associated where the data varied from the data threshold set. The exemplary method or another exemplary method may further provide wherein the welding machine is a rooftop seam welding machine. The exemplary method or another exemplary method may further provide wherein the welding machine is a pond liner seam welding machine. The exemplary method or another exemplary method may further provide wherein determining if the sensed data varies from the data threshold set comprises: establishing a set threshold value; tabulating the sensed data in a spreadsheet; comparing the sensed data to the set threshold value; generating an alarm if the sensed data is outside a variance window from the set threshold value. The exemplary method or another exemplary method may further provide wherein the set threshold value is an average of all the data points generated form that sensor and the variance window is a statistical outlier from the average, wherein statistical outlier refers to a sensed data point that is an abnormal distance from the average of the other data points. The exemplary method or another exemplary method may further provide wherein the abnormal distance from the average of the other data points is in a range from about +/−3% to about +/−25%. The exemplary method or another exemplary method may further provide wherein the set threshold value is a preselected value established prior to welding the overlapping region to create the welded seam. The exemplary method or another exemplary method may further provide entering the set threshold value, via user input, directly into the seam welding machine. The exemplary method or another exemplary method may further provide entering the set threshold value, via user input, into a computer that is located remotely from the seam welding machine. The exemplary method or another exemplary method may further provide obtaining an overhead image of an area in which the seam welding machine is moving along the overlapping region. The exemplary method or another exemplary method may further provide registering the overhead image with all data points generated form the at least one sensor based geolocation coordinates of the data points, and notifying a user of data point representing an anomaly or abnormality in the data. The exemplary method or another exemplary method may further provide registering the overhead image with only anomaly or abnormality data points generated form the at least one sensor based geolocation coordinates of the anomalous or abnormal data points. The exemplary method or another exemplary method may further provide wherein the overhead image is obtained via satellite imagery. The exemplary method or another exemplary method may further provide wherein the overhead image is an image of a roof. The exemplary method or another exemplary method may further provide wherein the overhead image is an image of a dried pond or pond bed. The exemplary method or another exemplary method may further provide: obtaining geolocation coordinates of anomalous or abnormal data points generated by the at least one sensor; providing the geolocation coordinates of the anomalous or abnormal data points generated by the at least one sensor to a smartphone or mobile computer carried by the operator of the seam welding machine. The exemplary method or another exemplary method may further provide wherein the step of determining if the sensed data varies from a data threshold set is accomplished by determining if a sensed temperature exceeds a set temperature value by more than 10 degrees. The exemplary method or another exemplary method may further provide wherein the step of determining if the sensed data varies from a data threshold set is accomplished by determining if a sensed temperature is less than 10 degrees or more from a set temperature value. The exemplary method or another exemplary method may further provide wherein the step of determining if the sensed data varies from a data threshold set is accomplished by: establishing an average speed of the machine moving along the overlapped region; determining if the speed of the machine at a single data point varies more than a set percentage, such as 3% or 5% or 10% or 15% from the average speed, and if the speed at the data point varies more than the set percentage, then indicating this data point as an anomaly and alerting the operator of the anomaly that needs physically inspected by an operator.

### BRIEF DESCRIPTION OF THE SEVERAL VIEWS OF THE DRAWINGS

A sample embodiment of the disclosure is set forth in the following description, is shown in the drawings and is particularly and distinctly pointed out and set forth in the appended claims. The accompanying drawings, which are fully incorporated herein and constitute a part of the specification, illustrate various examples, methods, and other example embodiments of various aspects of the disclosure. It will be appreciated that the illustrated element boundaries (e.g., boxes, groups of boxes, or other shapes) in the figures represent one example of the boundaries. One of ordinary skill in the art will appreciate that in some examples one element may be designed as multiple elements or that multiple elements may be designed as one element. In some examples, an element shown as an internal component of another element may be implemented as an external component and vice versa. Furthermore, elements may not be drawn to scale.

FIG. 1 (FIG. 1) is a diagrammatic view of an exemplary sheet material welding machine moving atop a roof in accordance with one aspect of the present disclosure.

FIG. 1A (FIG. 1A) is a schematic view of an exemplary network environment linking the welding machine with a database located on either a remote computer or a remote smartphone.

FIG. 2 (FIG. 2) is an exemplary top view of a welding machine moving across portions of a roof to weld adjacent strips of thermoelastic material together.

FIG. 3 (FIG. 3) is an exemplary enlarged top view of an area between two adjacent strips of thermoelastic roofing material identifying a plurality of data points collected from the welding machine and data point is associated with observed sensory data from a sensor carried by the welding machine.

FIG. 4 (FIG. 4) is a table identifying observed and recorded sensory data associated with each of the data points identified in FIG. 3.

FIG. 5 (FIG. 5) is a graph of the data points identified in FIG. 4 along the x-axis and various temperatures identified in FIG. 4 along the y-axis.

FIG. 6 (FIG. 6) is a top view of satellite imagery registering portions of the GPS calculated data points over the top of an image in order to predict a potential problem spot of a weld in order to enable a workman to spot check a precise area where the anomaly in the sensory data was observed.

FIG. 7 (FIG. 7) is an exemplary flow chart associated with the method of use in accordance with one aspect of the present disclosure.

FIG. 8 (FIG. 8) is an exemplary flow chart of another exemplary method in accordance with the present disclosure.

Similar numbers refer to similar parts throughout the drawings.

### DETAILED DESCRIPTION

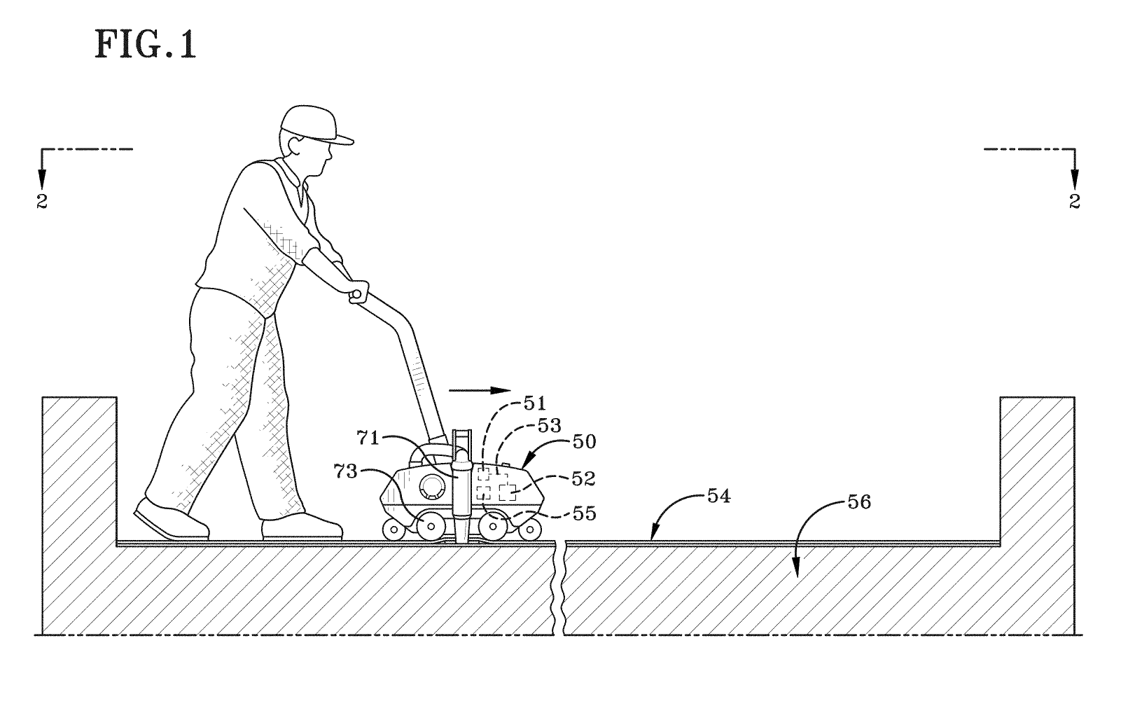

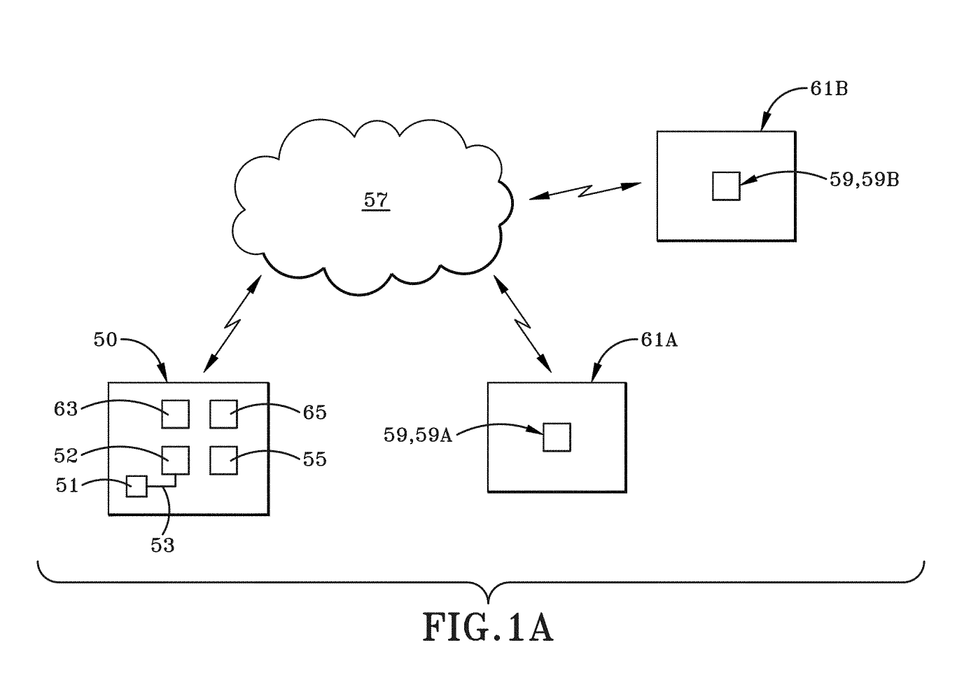

As depicted in FIG. 1, there is shown a welding machine in accordance with an aspect of the present disclosure, generally indicated at 50. Welding machine 50 is configured to weld roofing membranes and other flexible fabrics or materials. Specifically, machine 50 and the method of use thereof to weld flexible fabrics is operable in forward and reverse directions. One exemplary welding machine 50 is disclosed in co-owned and pending prior U.S. patent application Ser. No. 62/244,311, filed on Oct. 21, 2015 entitled “METHOD AND APPARATUS FOR WELDING ROOFING MEMBRANE” and disclosed in co-owned and pending prior U.S. patent application Ser. No. 15/296,697 filed on Oct. 18, 2016 entitled “METHOD AND APPARATUS FOR WELDING ROOFING MEMBRANE”, the entirety of each application is incorporated herein as if fully rewritten. All of the parts, pieces, and components identified in the incorporated disclosures are to be incorporated with various sensors (introduced below) which will allow these machines to record data pertaining to the weld created by the machine, wherein the sensors generate data points that are coupled with geolocation or GPS coordinates so as to allow an operator to identify the location where the data was generated in the event the data is abnormal and the operator can then manually inspect that location.

Machine 50 includes one or more sensors 52 that gather and sense data associated with the operation of machine 50 while welding a sheet of flexible material or fabric 54 upon a roof 56 in both the forward and reverse directions. Some exemplary sensors 52 capable of being electronically coupled with machine 50 (either integrally on machine 50 or remotely connected thereto) may include but are not limited to: accelerometers sensing accelerations experienced during rotation, translation, velocity/speed, location traveled, elevation gained; gyroscopes sensing movements during angular orientation and/or rotation, and rotation; altimeters sensing barometric pressure, altitude change, flights of stairs of lifted, local pressure changes, submersion in liquid; impellers measuring the amount of fluid passing thereby; Global Positioning sensors (Le., GPS) sensing location, elevation, distance traveled, velocity/speed; Photo/Light sensors sensing ambient light intensity, ambient day/night, UV exposure; light sensors sensing light wavelength watching, indoor v. outdoor environment; Temperature sensors sensing ambient air temperature, and environmental temperature, and welding air temperature, and weld temperature of the overlapped strips of material during the weld; pressure sensors to detect the amount of pressure imparted by rollers on machine 50 to press overlapped strips of material together, and Moisture Sensors sensing surrounding moisture levels; and speedometers for measuring either the speed of the machine 50 or speed of the pressure rollers for creating the weld, as well as tachometers for measuring the speed of the motor during the welding process.

In one example, the sensors 52 gather physical information and store the gathered data into one or more memories 51 carried by machine 50. For example, the memory 51 may be a repeatably removable SD card (or USB flash drive) or the memory may be integrated into a computer carried by machine 50. The memory 51 receives data over link 53 with sensor(s) 52 and stores sensor data that is obtained during the welding of material 56, which will described in greater detail below. The gathered data will be uploaded to a computer that can identify anomalies or abnormalities of the gathered data, and tie that data point to a physical location utilizing GPS so an operator can spot-check the weld integrity at that location where the anomaly is flagged.

FIG. 1A depicts an alternative embodiment in accordance with the present disclosure, the sensors 52 gather physical information and generate data pertaining to the integrity or quality of the weld based on the sensor 52. However, rather than storing the information in an on-board memory 51, the data generated by sensors 52 is wirelessly sent via conventionally known methods or wireless links, or other communication logic on machine 50, such as Bluetooth or via network connectivity 57 such as the internet, to a database or central server 59 in a remote location. In one embodiment, the database 59A is housed in a central location or remote computer 61A for the company that owns and operates machine 50. In another embodiment, the database 59B is stored on a cell phone, smart phone, or other mobile computer 61B of the operator operating machine 50. As will be described in greater detail below, when the sensor 52 data is sent to the database (either 59A or 59B), the locations of welding anomalies will populate automatically on the smart phone 61B of the operator/workman of machine 50. Furthermore, the data generated by sensors 52 can also be coupled with GPS coordinates that are simultaneously sent with each piece of data so as to allow the operator to identify the geolocation of where the sensed data was generated.

Machine 50 may further include a heater 71 and a roller 73, which may be a pressure roller, to respectively heat and apply pressure to overlapping strips of material thereby effectuating a welded seam as the seam welding machine moves along the overlapped material. More detailed explanation of the heater and roller is found in the preceding disclosure from which this disclosure is a CIP.

In another example, machine 50 may include at least one non-transitory computer readable storage medium 63 carried by the machine 50 having instructions encoded thereon that when executed by one or more processors 65 on the machine 50 implement operations to sense physical information relating to the welding of overlapped strips of material, the operations including (i) initiate a sensor, such as sensor 52, to sense information pertaining to the weld completed by the machine 50 between overlapping strips of sheet material (some exemplary information includes, but is not limited to GPS based geolocation information, welding temperature, machine speed, ambient air temperature, and ambient humidity); (ii) transfer the generated data to either (1) a remote database at either a central server or on a smartphone of the operator or (2) a memory 51 carried by the machine 50; (iii) effectuate the review of the sense data; (iv) generate an alarm if any of the sensed data deviates from a predetermined set of data ranges of what each piece of information for the weld should be at that location, wherein the alarm includes GPS coordinates so as to allow a workman/operator to spot check the physical weld at the location of where the alarm was generated; (v) effectuate the physical spot check of the weld at the location where the alarm was generated rather than requiring the workman to check the entire length of the weld, which should significantly reduce the inspection times of the operator/workman inasmuch as many projects on large industrial and commercial building may take a long time which clearly results in increased labor costs, amongst other costs. In this instance, medium 63 may replace memory 51. In another example, machine 50 includes both memory 51 and medium 63.

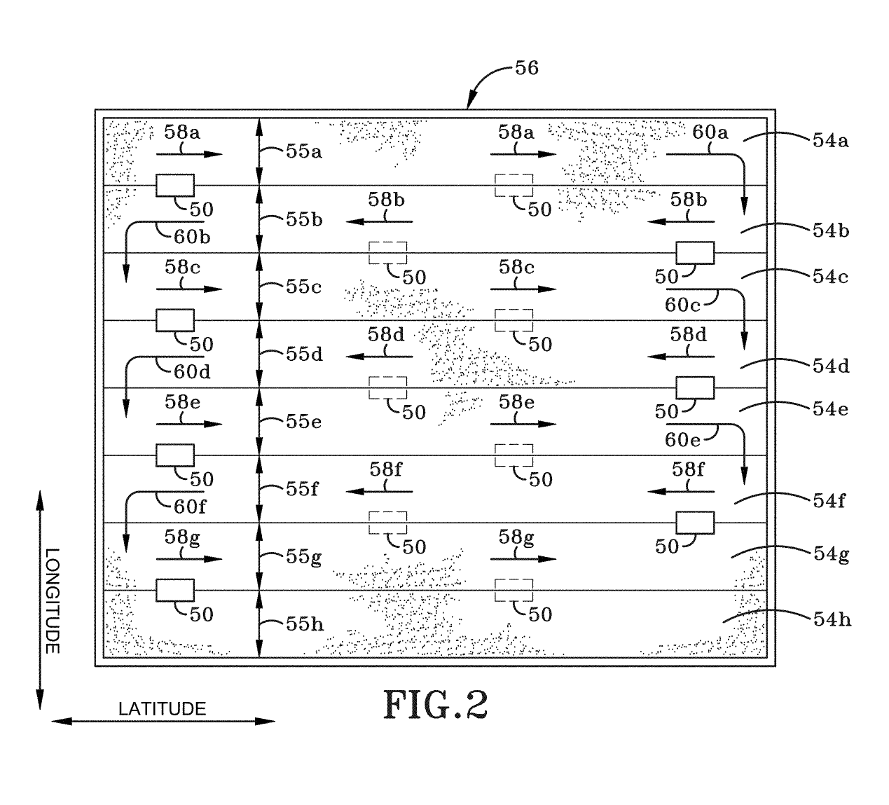

Referring now to FIG. 2, there is shown a plurality of roofing membrane strips 54a, 54b, 54c, 54d, 54e, 54f, 54g, 54h that have been laid over the roof 56. Preferably, each strip 54a-54h has an equal width 55a-55h respectively, however it is not necessary. The roofing membrane 54 (and its constituent strips 54a-54h) may be comprised of any suitable type of thermoplastic or other material that is able to be welded via application of heat and pressure. Strips 54a-54h are arranged in a parallel side-by-side configuration. Each strip 54a-54h has a first edge region and a second edge region. The first edge region one strip (i.e. strip 54a) overlaps the second edge region of an adjacent strip (i.e. strip 54b) to form an overlapped region.

FIG. 2 depicts welding machine 50 positioned upon the roof 56 that has a first end, a second end, a first side, and a second side. The plurality of strips of material 54a-54h are placed onto roof and edge regions thereof are overlapped with each other as will be described later herein. Welding machine 50 is positioned on the surface of this material and at a first end of the overlapped first and second strips 54a, 54b.

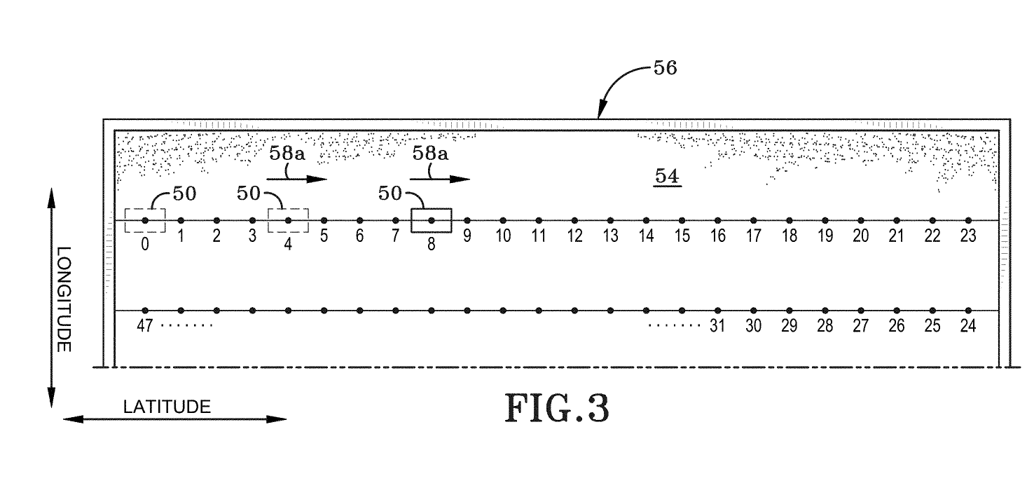

As depicted the FIG. 2 and FIG. 3, latitude coordinates and longitude coordinates are provided for reference purposes to assist with the description of components relative to each other and the direction along which axis they may move or perform a stated function. These coordinates will be obtained from a GPS-based sensor 55 on machine 50.

Welding machine 50 first moves in the direction of arrow 58a, which is in the direction along the latitude-axis, from its first end towards its second end. Once the welding machine 50 reaches the second end of first strip 54a, the operator may move certain welding components of machine 50 to effectuate the transition of the forward direction weld to the reverse direction as indicated in the aforementioned disclosures from which this disclosure is a CIP (i.e., U.S. patent application Ser. No. 15/296,697).

Welding machine 50 is shifted (in the direction of transition arrow 60a) from proximate the first overlapping region to proximate a second overlapping region (between strip 54b and strip 54c). This shifting may be accomplished by wheeling welding machine 50 across second strip 54b or by lifting welding machine 50 and carrying it over to the position above the second overlapping region. The shifting of machine 50 along transitional arrow 60a occurs primarily in a direction along the longitude-axis.

The operator may then engage a control on control panel that reverses the direction of current flowing through the motor of a blower motor assembly. This causes the motor to rotate in the opposite direction, thereby driving drive machine 50 in the opposite direction, thereby rotating a front wheel in the opposite direction. The effect of this change in the direction of current is that welding machine 50 essentially reverses along second overlapped region in the direction of arrow 58b which is generally along the latitude-axis offset from arrow 58a.

When the end of second overlapping region is reached, the operator will adjust components on machine 50 to effectuate the movement of the machine in the opposite direction. Welding machine 10 is then shifted laterally in the direction of transitional arrow 60b generally along the longitude-axis to position it adjacent a third overlapping region between third strip 54c and fourth strip 54d. Welding of the third overlapping region is then accomplished by moving welding machine 50 in the direction of arrow 56c along the third overlapping region. At the end of the third overlapping region, the welding machine is transferred in the direction of transitional arrow 60c and a fourth overlapping region is welded as machine 50 moves in the direction of arrow 58d.

It will be understood that this process continues a number of times equal to the number of overlapping regions and the directional arrows 58a-58g and transitional arrows 60a-60f correspond to the movement shown in the figures.

As depicted in FIG. 3, an exemplary operational top view is provided depicting welding machine 50 moving along the first overlap region in the direction of arrow 58a. As the welding machine moves in the direction of arrow 58a, which is along the latitude direction, the sensors collect a plurality of sensed data at individual data points. The data points are identified and labeled as point 0 through (−) point 47 in FIG. 3. However, it is to be understood that these points may be any number between zero and infinity along the welding region. The more data points that are collected along a welded overlap region, the higher precision for spot checking potentially problematic welds may be established.

With continued reference to FIG. 3, the 24 data points along the first overlapping region are not intended to be limiting and rather are merely provided for exemplary purposes to assist with the concise explanation of the operation of the present disclosure. One having ordinary skill in the art would easily understand and foresee that continuous data collection from sensors 52 on welding machine 50 as the welding machine moves in the direction of arrow 58a, between the ends of the first strip 54a, is entirely possible. Referring to data point 0 through data point 23 (24 data points total), as welding machine 50 is welding two adjacent strips of material together, one or more of the sensors 52 on welding machine 50 collect information associated with the welded seam during the welding process. For example, in the 24 data points, which are identified as data point 0-data point 23 identified in FIG. 3, the sensory data collected includes longitude information (from GPS sensor 55), latitude information (from GPS sensor 55), set and controlled welding temperature, the actual temperature of the weld plate, the speed of the welding machine 50, the blower output percentage, the ambient air temperature, the ambient humidity, the front surface temperature on the weld plate, and the rear surface temperature on the weld plate. At each data point, the information is collected and stored in a memory on the welding machine or a remote memory or remote database (in which case machine 50 would not need a memory 51). The sensor observed data saved on the memory 51 of the welding machine 50 may be tabulated in order to consistently graph the tabulated data as will be described in greater detail below. Alternatively, the data may be tabulated in a remote database, such as 59A or 59B.

Further, while the data identified in this particular example includes the above-referenced features, other additional sensed data by sensors 52 are entirely possible as one having ordinary skill in the art would understand and foresee. For example, if the sensor 52 is an accelerometer, then the accelerometer may sense accelerations experienced during rotation, translation, velocity/speed, location traveled, elevation gained of either the entire machine, or experienced by parts of the machine, such as the pressure rollers which may effect the strength of the weld. For example, if the sensor 52 is a gyroscope, then the gyroscope may sense angular movements of the entire machine, or parts of the machine, such as the pressure roller or other parts of the machine during the welding of the overlapped strips of material which may effect the integrity of the weld based one angular orientation and/or rotation, and rotation of these or other parts of the machine. For example, if the sensor 52 is an altimeter, then the altimeter may sense barometric pressure, altitude change, flights of stairs of lifted, local pressure changes of the machine, or of parts of the machine which may effect the integrity of the weld between overlapped strips of material. For example, if the sensor 52 is a Global Positioning sensors (i.e., GPS) sensing location, elevation, distance traveled, velocity/speed (in addition to the primary GPS 55 of the machine 50), then the GPS information may be utilized to determine if the machine 50 was traveling too quickly or too slow to effectuate a weld having sufficient integrity. For example, if sensor 52 is a pressure sensor, then the pressure sensor detect the amount of pressure imparted by rollers on machine 50 to press overlapped strips of material together. There may additionally be moisture sensors for sensing surrounding moisture levels. In each instance, the geolocation of each sensed data point is known based on the GPS carried by machine 50. This enables the data points to identify the position at which the data was generated by sensor 52, regardless of the sensor type. Thus, when data is populated into the database, the location is known and may be provided to the operator in the event an anomaly or abnormality is detected so as to allow the operator to walk to that precise location and check the weld via manual inspection.

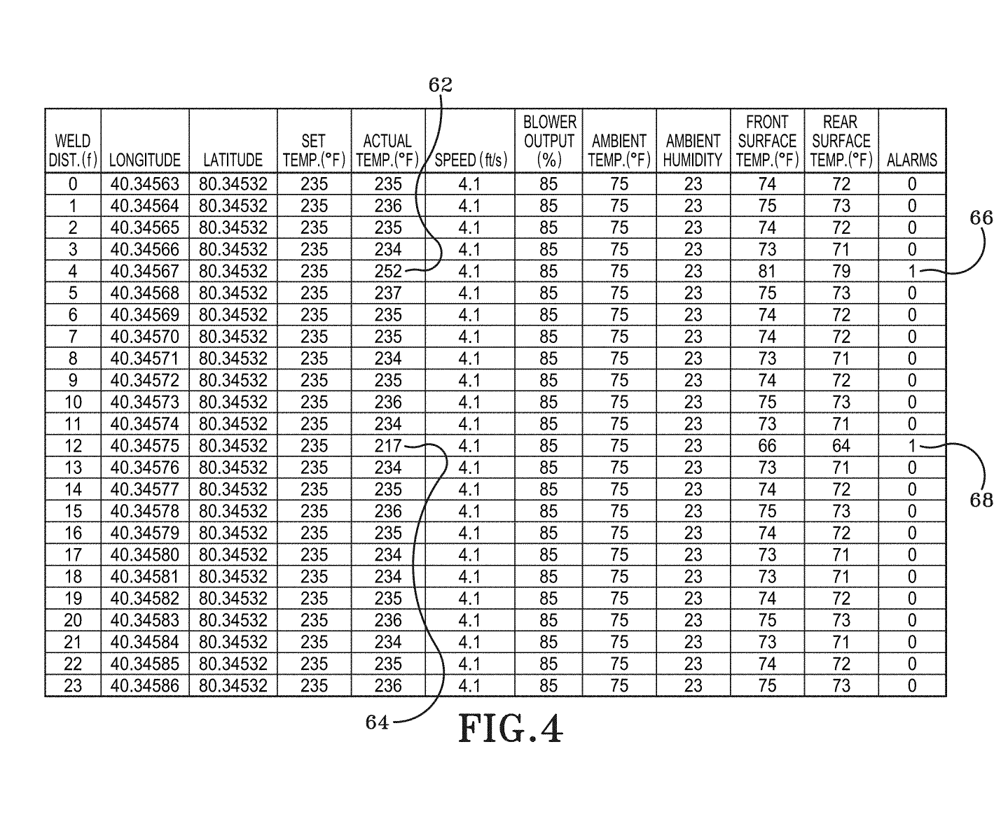

As depicted in FIG. 4, after the roof welding machine 50 has finished all the welds on the roof, the memory 51 may be removed and the tabulated sensory data connected to a computer and placed into a spreadsheet. By way of example, FIG. 4 depicts the 24 data points identified in the first overlapping region of FIG. 3. Again, these 24 data points are not intended to be limiting and are rather used by way of example as one having ordinary skill in the art would understand that there is no limit to the number of data points that may be collected. The more data points that are collected would essentially enable continuous data and sensory collection.

As is understood, this step could be substituted in a machine that does not carry a memory 51 for recording the data. Rather, the data could have been previously transferred via network 57 capabilities to a remote database where the points may populated in either real time or with some delay so as to allow a batch upload.

One or more GPS sensors 55 collect longitude and latitude information associated with at least one, a majority, or every data point. As shown in the table of FIG. 4, when welding machine 50 is moving in the direction of the latitude axis, the latitude coordinates would generally remain the same and the longitudinal coordinates would change and increase as indicated from data point 0 to data point 23. However, these coordinates will vary in actual use based on the orientation of the roof 56 as one having ordinarily skill in the art would understand and foresee.

One or more of the sensors 52 may be a thermometer to record the actual temperature of the hot air exiting the hot air welder when embodied as a hot air blower. As indicated at data point 4, some of the actual temperature readings may indicate an anomaly. For example, at data point 4 the actual temperature of the hot air exiting the blower is 252°. This is indicated generally at 62. The set temperature (also referred to as a set threshold) in this instance is 235°. Thus, the 252° actual reading observed from sensor 52 is a deviation from the set temperature 235°. By way of additional example, at data point 12 the actual temperature observed from one of the sensors is 217°. The 217° reading at data point 12 is indicated generally at 64, while the set temperature remains 235°.

When the sensed temperatures (or other data generated by the sensor) deviate significantly from the set temperature, an algorithm may initiate an alarm which may be tied to notification logic to alert an operator that an anomaly may exist at that specific GPS location. The alarm associated with the increased temperature shown at 62 is indicated generally at 66. Additionally, the alarm associated with the decreased temperature shown at 64 is indicated generally at 68. The examples explained above are described for brevity purposes with reference to the temperatures, however it is to be clearly understood that the same anomalies can be identified and indicate an alarm if one of the other columns significantly deviates from either a set value or if it deviates from an average value associated with each of the values in a respective column or set of data points. For example, the speeds are indicated as a consistent 4.1 feet per second. However, if one of the data points indicated a significantly higher or significantly lower speed, that may also trigger an alarm. Likewise, the blower output is consistent at 85% between all of the weld data points. However, if the blower output percentages deviated from the average of 85% in one of the data points, it may also indicate an alarm. Additionally it is contemplated that other factors or observed variables may be incorporated into the spreadsheet to record other observed/sensed data that may affect the integrity of the welded seam.

The deviations of the values from the set threshold values identified above are for exemplary purposes. There may be other instances where deviation within a percentage of the set threshold is permissible. For example, it may be possible for a deviation to be within +/−25% of the threshold value and still not trigger an alarm. For example, if the threshold value for a temperature sensor is 235°, there may be a scenario where only an alarm is triggered if the sensed temperature at the weld (note: the sensed temperature may be of the weld itself or of the heated wedge effectuating the weld carried by machine 50) is less than about 176° (235°×75%=about 176°) or greater than about 293° (235°×125%=about 293°). Other scenarios are possible where a deviation outside of +/−18% of the threshold value would trigger an alarm. Other scenarios are possible where a deviation outside of +/−20% of the threshold value would trigger an alarm. Other scenarios are possible where a deviation outside of +/−15% of the threshold value would trigger an alarm. Other scenarios are possible where a deviation outside of +/−12% of the threshold value would trigger an alarm. Other scenarios are possible where a deviation outside of +/−10% of the threshold value would trigger an alarm. Other scenarios are possible where a deviation outside of +/−8% of the threshold value would trigger an alarm. Other scenarios are possible where a deviation outside of +/−5% of the threshold value would trigger an alarm. Other scenarios are possible where a deviation outside of +/−3% of the threshold value would trigger an alarm. Furthermore, it is to be understood that these deviation values can apply to all of the sensor relative to their respective set threshold values, not the just the thermometer and temperature sensors depicted above.

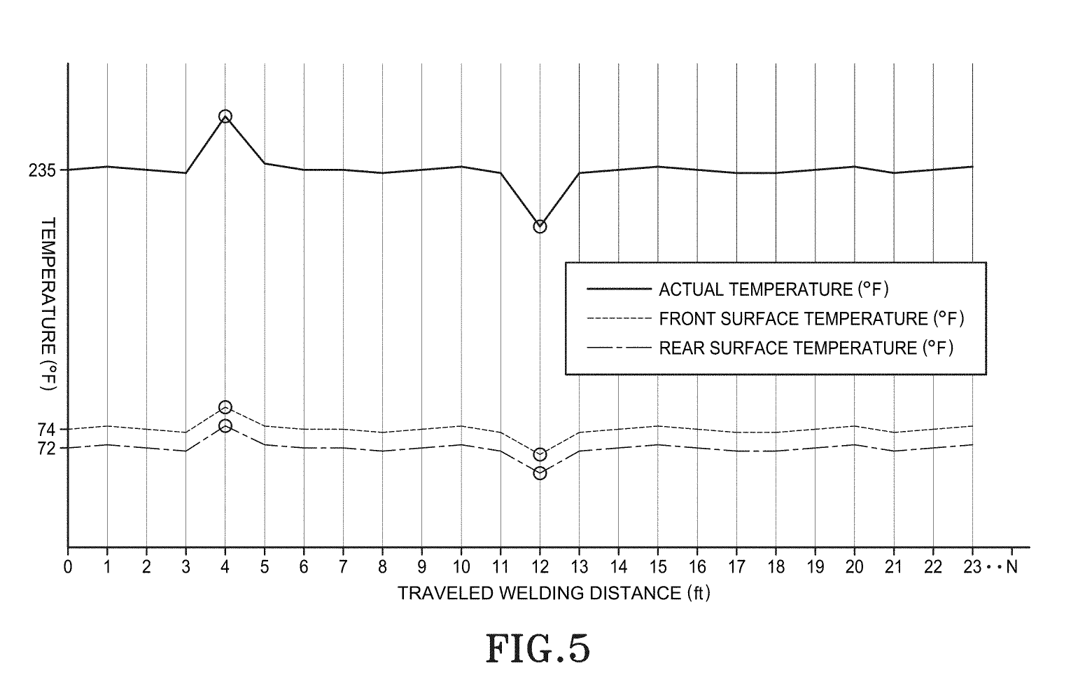

FIG. 5 depicts a graph with the data points along the x-axis and the temperatures along the y-axis. FIG. 5 shows that the data point 4 is indicative of an abnormality or anomaly because the apex crest of the data point appears to be significantly greater than the average of the remaining data points. This would indicate to an operator to obtain the GPS coordinates for that data point 4 and to move to that location on the roof to physically and manually spot check the weld in that location to ensure proper weld integrity. Similarly, data point 12 indicates a significant depression in the temperature data which could result in an improper weld at that location. Thus, an operator will take the GPS coordinate information, such as the longitude and latitude associated with data point 12 where the depression in temperature deviates from the norm or the set temperature, and check that spot on the roof for structural integrity of the weld.

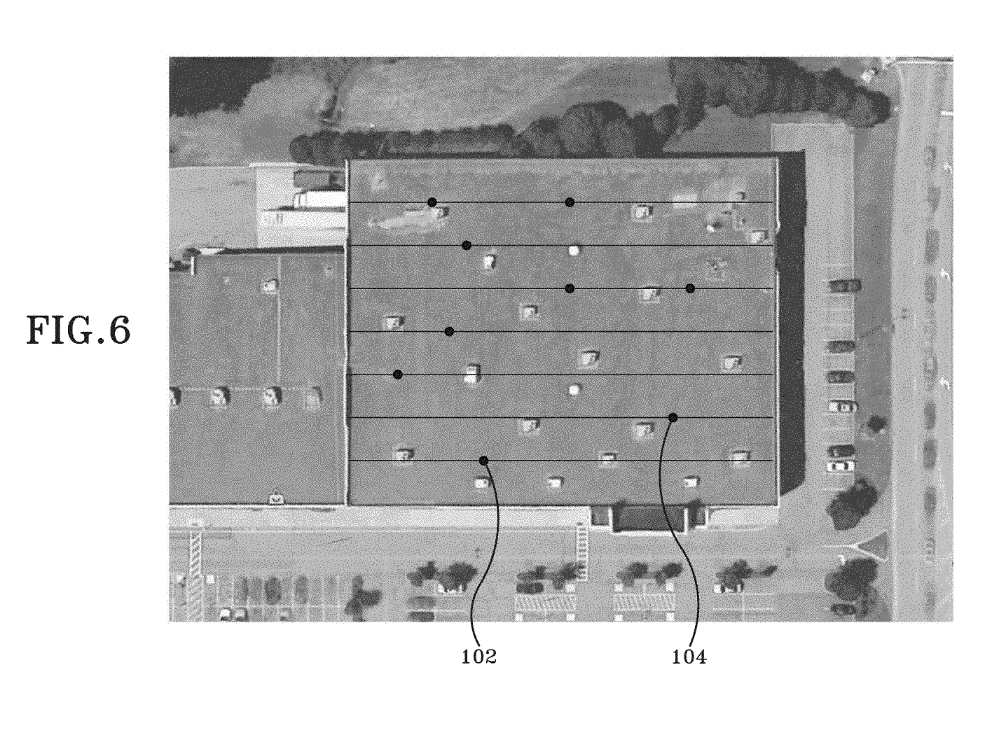

As indicated in FIG. 6, an exemplary data point set is plotted over or registered on a GPS-based and internet-obtained satellite top plan imagery of the building having the roof tarp material installed thereon (i.e., Google Maps imagery of the building). For example, the identified areas that may be associated with an alarm could be identified to give the roof operator or workman the necessary tool to quickly identify a potential problem area, thus expediting his checking of the seam integrity of the roof by proceeding directly to a highlighted location. One exemplary location is shown generally at 102 (this could refer to data point 4 of FIG. 5), which may correspond with either an increased temperature in the hot air welding plate or one of the other received sensory data that is a significant deviation from either a set point or an average of collected data, wherein “significant” refers to being a deviation that generates an alarm, as opposed to a slight deviation that is still within a threshold safe range of +/−X % of the threshold value. By way of non-limiting example, point 102 may identify a point where a potential problem area where a workman needs to check that the temperature of one of the sensors was in a range from 5, 10, or 15 or more degrees above the set temperature. Additionally, point 104 may indicate a potential problem area where the temperature of the blower was less than 5, 10, or 15 degrees below the set temperature. The remaining data points indicated are shown for exemplary purposes to indicate other areas that may be identified through the alarm logic in the event deviations from the sensory data are observed when plotted.

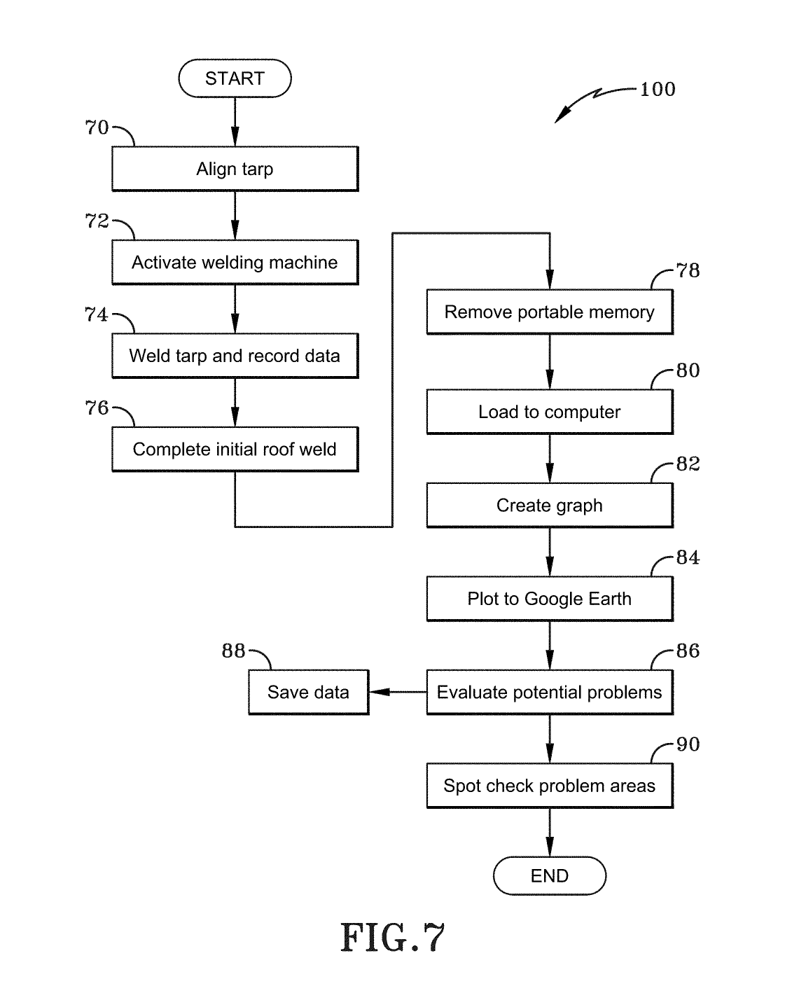

As depicted in FIG. 7, a method for tracking weld data and determining the integrity of a welded seam based on the track data is indicated generally at 100. Initially, an operator must align the tarp material, or the strips of tarp 54a-54h, which is generally indicated at 70. Then, the welding machine 50 is activated and heated up to a sufficient temperature that would effectuate welding between two adjacent strips of material, which is shown generally at 72. Next, the machine 50 is advanced forward in one direction to complete a welded seam while simultaneously collecting sensor data at data points having GPS coordinates associated therewith. The welding machine 50 may then continue to weld the pieces of tarp material together moving back and forth in a serpentine manner along the roof line as indicated in FIG. 2 and FIG. 3. The completion of the welded roof material 54 and the recorded data is indicated generally at 74. After the final weld has been completed, the roof welding process is considered complete, which is indicated generally at 76. In one particular embodiment, the memory 51 associated with storing the recorded sensory data is provided by a removable SD card. In such an instance, the removing of the portable memory 51 is indicated generally at 78. Then, the removable SD card and its stored sensory data is loaded onto a computer, which is indicated at 80. From the tabulated sensory data stored on the SD card, a graph is created similar to that of FIG. 5. Alternatively, there does not need to be a memory. The sensed data points may be transferred wirelessly in real time or as a batch upload to the computer (or smart phone or tablet). In this instance, the sensory data would be stored in a remote location for tabulated viewing by the operator.

The creation of the graph or table is indicated generally at 82. A computer having alarm logic may identify potential problem points or anomalies in the graph as indicated at data point 4 and data point 12 in FIG. 5. For example, the alarm logic may be in the form of instructions stored on the computer that when executed by one or more processors implement an operation identifying anomalies in the sensed data from a set of pre-set threshold data. For example, an alarm may be triggered when a temperature is too hot or too cold relative to some component of the weld or the machine effectuating the weld. After identifying the data that generated an alarm, the alarm logic may either highlight or provided another notification to call attention to the operator. With the alarms highlighted and called out, the coordinates may be plotted to a GPS based overhead image function where the alarmed data points are identified, as indicated in FIG. 6. This step is generally shown at 84. In another implementation, the plotting of the data points may utilize a Google Earth image overlay, or image registration, and this is also indicated at step 84. The evaluation of the potential problem points comes thereafter, which is indicated generally at 86. After the warning areas and alarmed data points have been highlighted, the data may be saved in a secondary memory such that the information is permanently stored in case it needs to be re-evaluated a second time. With the plotted information, an operator or a workman on the roof may identify the GPS coordinates and proceed thereto to visually and physically inspect the integrity of the welded seam at that specific highlighted potential problem area.

It is readily apparent that the method of using sensory data obtained from the welding machine 50 significantly reduces the amount of time an operator needs to physically check the welded seam integrity. As indicated in the background section, current known methods may weld strips of thermoelastic material together, but a workman needs to check the entire length of the seam for seam integrity and quality. With the method 100 and machine 50 having sensors 52 therein, a workman's time is significantly reduced, thus imparting a cost savings to the end user based on the lessened amount of time needed to physically spot check the entire roof weld.

Additional embodiments within the scope of the present disclosure may expand the field of use of welding machine 50. For example, machine 50 may be removed from the rooftop environment and be used to accomplish similar welding and seam tracking methods for ground-based welded sheet material.

These circumstances often apply to pond liners or liners for land fill pits. For example, machine 50 and its various sensors could incorporate GPS coordinates in combination with accelerometers or other gyroscopic sensors configured to measure angles of the machine 50 relative to the ground during the welding process. This is because ponds and landfills and other ground-based areas having welded liners are often not flat like a rooftop.

Thus, the machine 50 utilize in a ground-based scenario would track the weld data and would require another coordinate column for height relative to sea level due to the X-axis, Y-axis, and Z-axis variations of pond liners and landfill liners which would be recorded at the alarm location.

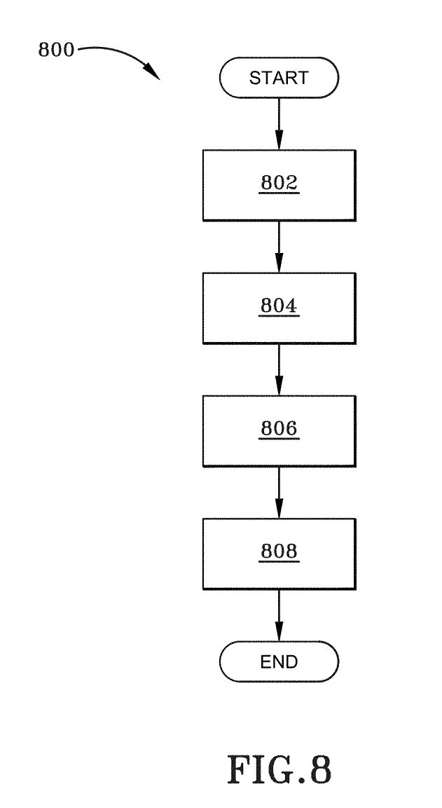

FIG. 8 is a flow chart of another exemplary method in accordance with the present disclosure. A method of tracking welded seam data is shown generally at 800. The method 800 may include moving the seam welding machine 50 along an overlapping region defined by adjacent overlapped strips of sheet material (such as 54a and 54b), which is shown generally at 802. Welding the overlapping region to create a welded seam as the machine 50 moves therealong and simultaneously sensing data associated with the welded seam with one or more sensors 52 carried by the machine, wherein the sensed data includes coordinate-based location data for each data point obtained by GPS 55 is shown generally at 804. Determining if the sensed data varies from a data threshold set, and if so, then alerting an operator of a potential weld failure at the coordinated-based location of that data point associated where the data varied from the data threshold set is shown generally at 806. And, effecting the manual and physical spot checking the welded seam integrity at the coordinated-based location of that data point associated where the data varied from the data threshold set is shown generally at 808.

Method 800 may further include wherein the welding machine 50 is a rooftop seam welding machine. Or, wherein the welding machine is a pond liner seam welding machine. Method 800 may also include wherein determining if the sensed data varies from the data threshold set comprises: establishing a set threshold value; tabulating the sensed data in a spreadsheet; comparing the sensed data to the set threshold value; and generating an alarm if the sensed data is outside a variance window from the set threshold value. In one example, the set threshold value is an average of all the data points generated form that sensor and the variance window is a statistical outlier from the average, wherein statistical outlier refers to a sensed data point that is an abnormal distance from the average of the other data points. In one instance, the abnormal distance from the average of the other data points is in a range from about +/−3% to about +1-25%. In another instance, the set threshold value is a preselected value established prior to welding the overlapping region to create the welded seam. One embodiment enables a user to enter the set threshold value, via user input, directly into the seam welding machine. Alternatively, the user may enter the set threshold value, via user input, into a computer such as 61A or 61B that is located remotely from the seam welding machine.

Method 800 further comprises obtaining an overhead image of an area in which the seam welding machine is moving along the overlapping region. Thereafter, registering the overhead image with some or all data points generated from the at least one sensor based geolocation coordinates of the data points, and notifying a user of data point representing an anomaly or abnormality in the data. An alternative provides registering the overhead image with only anomalies or abnormal data points generated form the at least one sensor based geolocation coordinates of the anomalous or abnormal data points. In these scenarios, the overhead image is obtained via satellite imagery. In one example, the overhead image is an image of a roof. And, in another example, the overhead image is an image of a dried pond or pond bed.

Method 800 may further provide obtaining geolocation coordinates of anomalous or abnormal data points generated by the at least one sensor; and providing the geolocation coordinates of the anomalous or abnormal data points generated by the at least one sensor to a smartphone or mobile computer carried by the operator of the seam welding machine. Method 800 may further provide wherein the step of determining if the sensed data varies from a data threshold set is accomplished by determining if a sensed temperature exceeds a set temperature value by more than 10 degrees. Additionally, the step of determining if the sensed data varies from a data threshold set may be accomplished by determining if a sensed temperature is less than 10 degrees or more from a set temperature value. In another example, the step of determining if the sensed data varies from a data threshold set may be accomplished by: establishing an average speed of the machine moving along the overlapped region; determining if the speed of the machine at a single data point varies more than a set percentage, such as 3% or 5% or 10% or 15% from the average speed, and if the speed at the data point varies more than the set percentage, then indicating this data point as an anomaly and alerting the operator of the anomaly that needs physically inspected by an operator.

Also, various inventive concepts may be embodied as one or more methods, of which an example has been provided. The acts performed as part of the method may be ordered in any suitable way. Accordingly, embodiments may be constructed in which acts are performed in an order different than illustrated, which may include performing some acts simultaneously, even though shown as sequential acts in illustrative embodiments.

While various inventive embodiments have been described and illustrated herein, those of ordinary skill in the art will readily envision a variety of other means and/or structures for performing the function and/or obtaining the results and/or one or more of the advantages described herein, and each of such variations and/or modifications is deemed to be within the scope of the inventive embodiments described herein. More generally, those skilled in the art will readily appreciate that all parameters, dimensions, materials, and configurations described herein are meant to be exemplary and that the actual parameters, dimensions, materials, and/or configurations will depend upon the specific application or applications for which the inventive teachings is/are used. Those skilled in the art will recognize, or be able to ascertain using no more than routine experimentation, many equivalents to the specific inventive embodiments described herein. It is, therefore, to be understood that the foregoing embodiments are presented by way of example only and that, within the scope of the appended claims and equivalents thereto, inventive embodiments may be practiced otherwise than as specifically described and claimed. Inventive embodiments of the present disclosure are directed to each individual feature, system, article, material, kit, and/or method described herein. In addition, any combination of two or more such features, systems, articles, materials, kits, and/or methods, if such features, systems, articles, materials, kits, and/or methods are not mutually inconsistent, is included within the inventive scope of the present disclosure.

The above-described embodiments can be implemented in any of numerous ways. For example, embodiments of technology disclosed herein may be implemented using hardware, software, or a combination thereof. When implemented in software, the software code can be executed on any suitable processor or collection of processors, whether provided in a single computer or distributed among multiple computers.

Also, a computer or smartphone may have one or more input and output devices. These devices can be used, among other things, to present a user interface. Examples of output devices that can be used to provide a user interface include printers or display screens for visual presentation of output and speakers or other sound generating devices for audible presentation of output. Examples of input devices that can be used for a user interface include keyboards, touchscreens, and pointing devices, such as mice, touch pads, and digitizing tablets. As another example, a computer may receive input information through speech recognition or in other audible format.

Such computers or smartphones may be interconnected by one or more networks in any suitable form, including a local area network or a wide area network, such as an enterprise network, and intelligent network (IN) or the Internet. Such networks may be based on any suitable technology and may operate according to any suitable protocol and may include wireless networks, wired networks or fiber optic networks.

The various methods or processes outlined herein may be coded as software that is executable on one or more processors that employ any one of a variety of operating systems or platforms. Additionally, such software may be written using any of a number of suitable programming languages and/or programming or scripting tools, and also may be compiled as executable machine language code or intermediate code that is executed on a framework or virtual machine.

In this respect, various inventive concepts may be embodied as a computer readable storage medium (or multiple computer readable storage media) (e.g., a computer memory, one or more floppy discs, compact discs, optical discs, magnetic tapes, flash memories, USB flash drives, SD cards, circuit configurations in Field Programmable Gate Arrays or other semiconductor devices, or other non-transitory medium or tangible computer storage medium) encoded with one or more programs that, when executed on one or more computers or other processors, perform methods that implement the various embodiments of the disclosure discussed above. The computer readable medium or media can be transportable, such that the program or programs stored thereon can be loaded onto one or more different computers or other processors to implement various aspects of the present disclosure as discussed above.

The terms “program” or “software” are used herein in a generic sense to refer to any type of computer code or set of computer-executable instructions that can be employed to program a computer or other processor to implement various aspects of embodiments as discussed above. Additionally, it should be appreciated that according to one aspect, one or more computer programs that when executed perform methods of the present disclosure need not reside on a single computer or processor, but may be distributed in a modular fashion amongst a number of different computers or processors to implement various aspects of the present disclosure.

Computer-executable instructions may be in many forms, such as program modules, executed by one or more computers or other devices. Generally, program modules include routines, programs, objects, components, data structures, etc. that perform particular tasks or implement particular abstract data types. Typically the functionality of the program modules may be combined or distributed as desired in various embodiments.

Also, data structures may be stored in computer-readable media in any suitable form. For simplicity of illustration, data structures may be shown to have fields that are related through location in the data structure. Such relationships may likewise be achieved by assigning storage for the fields with locations in a computer-readable medium that convey relationship between the fields. However, any suitable mechanism may be used to establish a relationship between information in fields of a data structure, including through the use of pointers, tags or other mechanisms that establish relationship between data elements.

All definitions, as defined and used herein, should be understood to control over dictionary definitions, definitions in documents incorporated by reference, and/or ordinary meanings of the defined terms.

“Logic”, as used herein, includes but is not limited to hardware, firmware, software and/or combinations of each to perform a function(s) or an action(s), and/or to cause a function or action from another logic, method, and/or system. For example, based on a desired application or needs, logic may include a software controlled microprocessor, discrete logic like a processor (e.g., microprocessor), an application specific integrated circuit (ASIC), a programmed logic device, a memory device containing instructions, an electric device having a memory, or the like. Logic may include one or more gates, combinations of gates, or other circuit components. Logic may also be fully embodied as software. Where multiple logics are described, it may be possible to incorporate the multiple logics into one physical logic. Similarly, where a single logic is described, it may be possible to distribute that single logic between multiple physical logics.

Furthermore, the logic(s) presented herein for accomplishing various methods of this system may be directed towards improvements in existing computer-centric or internet-centric technology that may not have previous analog versions. The logic(s) may provide specific functionality directly related to structure that addresses and resolves some problems identified herein. The logic(s) may also provide significantly more advantages to solve these problems by providing an exemplary inventive concept as specific logic structure and concordant functionality of the method and system. Furthermore, the logic(s) may also provide specific computer implemented rules that improve on existing technological processes. The logic(s) provided herein extends beyond merely gathering data, analyzing the information, and displaying the results.

The indefinite articles “a” and “an,” as used herein in the specification and in the claims, unless clearly indicated to the contrary, should be understood to mean “at least one.” The phrase “and/or,” as used herein in the specification and in the claims (if at all), should be understood to mean “either or both” of the elements so conjoined, i.e., elements that are conjunctively present in some cases and disjunctively present in other cases. Multiple elements listed with “and/or” should be construed in the same fashion, i.e., “one or more” of the elements so conjoined. Other elements may optionally be present other than the elements specifically identified by the “and/or” clause, whether related or unrelated to those elements specifically identified. Thus, as a non-limiting example, a reference to “A and/or B”, when used in conjunction with open-ended language such as “comprising” can refer, in one embodiment, to A only (optionally including elements other than B); in another embodiment, to B only (optionally including elements other than A); in yet another embodiment, to both A and B (optionally including other elements); etc. As used herein in the specification and in the claims, “or” should be understood to have the same meaning as “and/or” as defined above. For example, when separating items in a list, “or” or “and/or” shall be interpreted as being inclusive, i.e., the inclusion of at least one, but also including more than one, of a number or list of elements, and, optionally, additional unlisted items. Only terms clearly indicated to the contrary, such as “only one of” or “exactly one of,” or, when used in the claims, “consisting of,” will refer to the inclusion of exactly one element of a number or list of elements. In general, the term “or” as used herein shall only be interpreted as indicating exclusive alternatives (i.e. “one or the other but not both”) when preceded by terms of exclusivity, such as “either,” “one of,” “only one of,” or “exactly one of.” “Consisting essentially of,” when used in the claims, shall have its ordinary meaning as used in the field of patent law.

As used herein in the specification and in the claims, the phrase “at least one,” in reference to a list of one or more elements, should be understood to mean at least one element selected from any one or more of the elements in the list of elements, but not necessarily including at least one of each and every element specifically listed within the list of elements and not excluding any combinations of elements in the list of elements. This definition also allows that elements may optionally be present other than the elements specifically identified within the list of elements to which the phrase “at least one” refers, whether related or unrelated to those elements specifically identified. Thus, as a non-limiting example, “at least one of A and B” (or, equivalently, “at least one of A or B,” or, equivalently “at least one of A and/or B”) can refer, in one embodiment, to at least one, optionally including more than one, A, with no B present (and optionally including elements other than B); in another embodiment, to at least one, optionally including more than one, B, with no A present (and optionally including elements other than A); in yet another embodiment, to at least one, optionally including more than one, A, and at least one, optionally including more than one, B (and optionally including other elements); etc.

In the claims, as well as in the specification above, all transitional phrases such as “comprising,” “including,” “carrying,” “having,” “containing,” “involving,” “holding,” “composed of,” and the like are to be understood to be open-ended, i.e., to mean including but not limited to. Only the transitional phrases “consisting of” and “consisting essentially of” shall be closed or semi-closed transitional phrases, respectively, as set forth in the United States Patent Office Manual of Patent Examining Procedures.

An embodiment is an implementation or example of the present disclosure. Reference in the specification to “an embodiment,” “one embodiment,” “some embodiments,” “one particular embodiment,” or “other embodiments,” or the like, means that a particular feature, structure, or characteristic described in connection with the embodiments is included in at least some embodiments, but not necessarily all embodiments, of the disclosure. The various appearances “an embodiment,” “one embodiment,” “some embodiments,” “one particular embodiment,” or “other embodiments,” or the like, are not necessarily all referring to the same embodiments.

If this specification states a component, feature, structure, or characteristic “may”, “might”, or “could” be included, that particular component, feature, structure, or characteristic is not required to be included. If the specification or claim refers to “a” or “an” element, that does not mean there is only one of the element. If the specification or claims refer to “an additional” element, that does not preclude there being more than one of the additional element.

In the foregoing description, certain terms have been used for brevity, clearness, and understanding. No unnecessary limitations are to be implied therefrom beyond the requirement of the prior art because such terms are used for descriptive purposes and are intended to be broadly construed.

Moreover, the description and illustration of the preferred embodiment of the disclosure are an example and the disclosure is not limited to the exact details shown or described.

What is claimed:

1. A method of tracking welded seam data comprising the steps of:
moving a seam welding machine along an overlapping region defined by adjacent overlapped strips of sheet material;
welding the overlapping region to create a welded seam as the machine moves therealong and simultaneously sensing data associated with the welded seam with one or more sensors carried by the machine, wherein the sensed data includes coordinate-based location data for each data point;
determining if the sensed data varies from a data threshold set, and if so, then alerting an operator of a potential weld failure at the coordinated-based location of that data point associated where the data varied from the data threshold set; and
effecting the manual and physical spot checking of the welded seam integrity at the coordinated-based location of that data point associated with where the data point varied from the data threshold set.

2. The method of claim 1, wherein the seam welding machine is a rooftop seam welding machine.

3. The method of claim 1, wherein the seam welding machine is a pond liner seam welding machine.

4. The method of claim 1, wherein determining if the sensed data varies from the data threshold set comprises:
establishing a set threshold value;
tabulating the sensed data in a spreadsheet;
comparing the sensed data to the set threshold value; and
generating an alarm if the sensed data is outside a variance window from the set threshold value.

5. The method of claim 4, wherein the set threshold value is an average of all the data points generated form that sensor and the variance window is a statistical outlier from the average, wherein statistical outlier refers to a sensed data point that is an abnormal distance from the average of the other data points.

6. The method of claim 5, wherein the abnormal distance from the average of the other data points is in a range from about +/−3% to about +/−25%.

7. The method of claim 4, wherein the set threshold value is a preselected value established prior to welding the overlapping region to create the welded seam.

8. The method of claim 7, further comprising:
entering the set threshold value, via user input, directly into the seam welding machine.

9. The method of claim 7, further comprising:
entering the set threshold value, via user input, into a computer that is located remotely from the seam welding machine.

10. The method of claim 1, further comprising:
obtaining an overhead image of an area in which the seam welding machine is moving along the overlapping region.

11. The method of claim 10, further comprising:
registering the overhead image with all data points generated form the at least one sensor based geolocation coordinates of the data points, and notifying a user of data point representing an anomaly or abnormality in the data.

12. The method of claim 10, further comprising:
registering the overhead image with only anomaly or abnormality data points generated form the at least one sensor.

13. The method of claim 10, wherein the overhead image is obtained via satellite imagery.

14. The method of claim 10, wherein the overhead image is an image of a roof.

15. The method of claim 10, wherein the overhead image is an image of a dried pond or pond bed.

16. The method of claim 1, further comprising:
obtaining geolocation coordinates of anomalous or abnormal data points generated by the at least one sensor;
providing the geolocation coordinates of the anomalous or abnormal data points generated by the at least one sensor to a smartphone or mobile computer carried by the operator of the seam welding machine.

17. The method of claim 1, wherein the step of determining if the sensed data varies from a data threshold set is accomplished by determining if a sensed temperature exceeds a set temperature value by more than 10 degrees.

18. The method of claim 1, wherein the step of determining if the sensed data varies from a data threshold set is accomplished by determining if a sensed temperature is less than 10 degrees or more from a set temperature value.

19. The method of claim 1, wherein the step of determining if the sensed data varies from a data threshold set is accomplished by:
establishing an average speed of the machine moving along the overlapped region;
determining if the speed of the machine at a single data point varies more than a set percentage in a range from 3% to 15% from the average speed, and if the speed at the data point varies more than the set percentage, then indicating this data point as an anomaly and alerting the operator of the anomaly that needs physically inspected by an operator.

20. A method of use for determining integrity and quality of a welded seam based on tracked weld data comprising:
effecting the collection of sensor data at data points having GPS coordinates associated therewith from a sensor on a moveable seam welding machine;
effecting the loading the sensor data onto a computer for processing;
viewing an alarm in the event some of the sensor data deviates from a threshold value; and
proceeding to the GPS coordinates of a data point that generated the alarm to visually and physically inspect the integrity of the welded seam at that specific location.

21. The method of claim 20, further comprising:
aligning strips of weldable material;
activating a moveable seam welding machine; and
advancing the seam welding machine forwardly along the aligned strips of weldable material.

22. The method of claim 21, further comprising:
effecting the graphing the sensor data;
viewing plotted GPS coordinates of the data point that generated the alarm; and
wherein the alarm is generated by alarm logic determining whether the sensor data deviates by more than a set threshold from a preset value.
